(19) United States
(12) Patent Application Publication
(10) Pub. No.: US 2023/0185609 A1
(43) Pub. Date: Jun. 15, 2023

(54) APPARATUS AND METHOD FOR SCHEDULING EXECUTION OF A TASK

(71) Applicant: Intel Corporation, Santa Clara, CA (US)

(72) Inventor: Rajesh POORNACHANDRAN, Portland, OR (US)

(21) Appl. No.: 18/145,868

(22) Filed: Dec. 23, 2022

(51) Int. Cl. G06F 9/48; G06F 9/50

(52) U.S. Cl. CPC G06F 9/4881; G06F 9/5038

(57) ABSTRACT

An apparatus is provided comprising interface circuitry, machine-readable instructions, and processing circuitry to execute the machine-readable instructions to receive a request to execute a task on a computing system, receive a requirement of the task for usage of a resource of the computing system, and schedule execution of the task by reserving at least part of the resource for the execution of the task based on the requirement.

### BACKGROUND

Conventionally, resources of a computing system may stay unidentified on a platform level. This may lead to starvation during scheduling of tasks requesting the resources. Hence, there may be a demand for improved scheduling.

### BRIEF DESCRIPTION OF THE FIGURES

Some examples of apparatuses and/or methods will be described in the following by way of example only, and with reference to the accompanying figures, in which

FIGS. 1a and 1b illustrate an example of an apparatus;

FIG. 2 illustrates an example of a schedule diagram;

FIG. 3 illustrates an example of an architecture of a computing system;

FIG. 4 illustrates an example of a method;

FIG. 5 illustrates an example of a method for static resource configuration;

FIG. 6 illustrates an example of a method for dynamic resource configuration; and

FIG. 7 illustrates an example of a method for dynamic resource configuration with negotiability.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

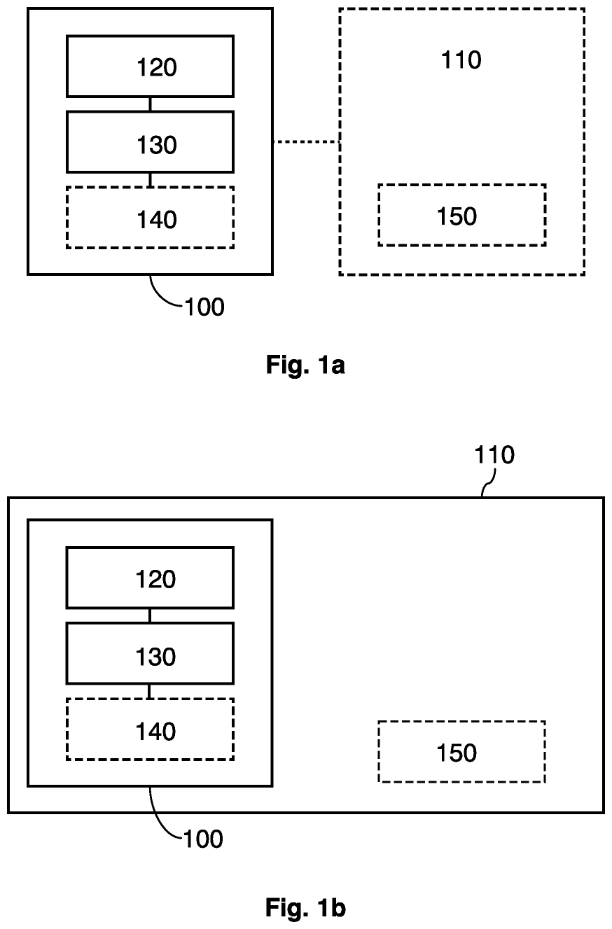

FIG. 1a shows a block diagram of an example of an apparatus 100 or device 100 communicatively coupled to a computer system 110. FIG. 1b shows a block diagram of an example of a computer system 110 comprising an apparatus 100 or device 100.

The apparatus 100 comprises circuitry that is configured to provide the functionality of the apparatus 100. For example, the apparatus 100 of FIGS. 1a and 1b comprises interface circuitry 120, processing circuitry 130 and (optional) storage circuitry 140. For example, the processing circuitry 130 may be coupled with the interface circuitry 120 and with the storage circuitry 140.

For example, the processing circuitry 130 may be configured to provide the functionality of the apparatus 100, in conjunction with the interface circuitry 120 (for exchanging information, e.g., with other components inside or outside the computer system 110) and the storage circuitry 140 (for storing information, such as machine-readable instructions).

Likewise, the device 100 may comprise means that is/are configured to provide the functionality of the device 100.

The components of the device 100 are defined as component means, which may correspond to, or implemented by, the respective structural components of the apparatus 100. For example, the device 100 of FIGS. 1a and 1b comprises means for processing 130, which may correspond to or be implemented by the processing circuitry 130, means for communicating 120, which may correspond to or be implemented by the interface circuitry 120, and (optional) means for storing information 140, which may correspond to or be implemented by the storage circuitry 140. In the following, the functionality of the device 100 is illustrated with respect to the apparatus 100. Features described in connection with the apparatus 100 may thus likewise be applied to the corresponding device 100.

For example, the storage circuitry 140 or means for storing information 140 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

In general, the functionality of the processing circuitry 130 or means for processing 130 may be implemented by the processing circuitry 130 or means for processing 130 executing machine-readable instructions. Accordingly, any feature ascribed to the processing circuitry 130 or means for processing 130 may be defined by one or more instructions of a plurality of machine-readable instructions. The apparatus 100 or device 100 may comprise the machine-readable instructions, e.g., within the storage circuitry 140 or means for storing information 140.

The apparatus 100 relates to the context of resource management of the computing system 110. The computing system 110 may have a plurality of resources, such as resource 150. Such resource 150 may be any physical or virtual (system) resource of limited availability within the computing system 110. The resource management of the apparatus 100 may include orchestration and/or scheduling of, e.g., access, usage and release of the plurality of resources.

Non-limiting examples of the resource 150 may be: a processor (processing unit) of any architecture such as a CPU (central processing unit) a GPU (graphics processing unit), an accelerator or an FPGA (field programmable gate array); a processing core (of a processor); a device connected to the computing system 110; an I/O (input/output) or network link such as a network socket or pipe, e.g., PCIe (peripheral component interconnect express), UPI (ultra path interconnect) or CXL (compute express link); memory such as LLC (last level cache) or a file handle.

The resource 150 may further have one or more dimensions of usage. For instance, usage of the resource 150 may define, e.g., a time of usage, a bandwidth, an electrical power, a frequency, a utilization rate, a latency, a configuration, etc. of the resource 150. It may depend on the type of the resource 150 and a type of workload demanding the resource 150 which dimension(s) are to be defined for usage of the resource 150.

In some example, the resource 150 is a resource shared by a plurality of processing cores of the computing system 110. The processing cores may be cores of any XPU (X processing unit, i.e., a processing unit of any architecture (e.g., a CPU or a non-CPU processing unit, e.g., GPU, FPGA, etc.). Such a shared resource may be, e.g., shared LLC, memory (bandwidth), UPI, PCIe, CXL (lane), a shared attach point to I/O, memory or cache, or any further XPU. In some examples, the resource 150 is at least one of a processing (XPU), storing (memory or cache) or communication resource (network, link).

The interface circuitry 120 is configured to receive a request to execute a task on the computing system 110. The task may be any part of a workload, a virtual thread, a process, a job or a data flow. The interface circuitry 120 may receive the request from the computing system 110 itself or from an external device (e.g., a user device) via any communicative coupling (wired or wireless). The interface circuitry 120 is further configured to receive a requirement of the task for usage of a resource 150 of the computing system 110. The interface circuitry 120 may, e.g., receive the requirement likewise from the computing system 110 or from an external device via any communicative coupling. In other examples, the processing circuitry 130 may determine the requirement from specifications of the task.

The interface circuitry 120 or means for communicating 120 may correspond to one or more inputs and/or outputs for receiving and/or transmitting information, which may be in digital (bit) values according to a specified code, within a module, between modules or between modules of different entities. For example, the interface circuitry 120 or means for communicating 120 may comprise circuitry configured to receive and/or transmit information.

The requirement may be a service-level agreement, for instance. The requirement may statically (before execution) or dynamically (with the ability of amendment during execution) define a dimension of the resource 150 to be reserved for the task. For example, the requirement may indicate at least one of a desired value of the resource to be provided for the execution of the task and a desired time for completion of the task. In some examples, the requirement indicates at least one of a processing frequency, a memory bandwidth, a cache size, a processor characteristic (or type of processor), an interconnect latency and an accelerator configuration. For instance, the requirement may indicate a resource profile in an SLA template.

A concrete example of such a resource profile defining different resource constraints is illustrated by the following Code 1. Each of the entries may define a specific value of a respective dimension of a plurality of resources (including resource 150).

Struct Resource_Constraint_SLA_Template {

UINT32 Fmin, % minimum value of a frequency of a first resource required for execution of the task;

UINT32 Fdesired, % desired value of a frequency of the first resource for execution of the task;

UINT32 MemBWmin, % minimum value of a memory bandwidth of a second resource required for execution of the task;

UINT32 MemBWdesired, % desired value of a memory bandwidth of the second resource for execution of the task;

UINT32 CacheSizemin, % minimum value of a cache size of a third resource required for execution of the task;

UINT32 CacheSizedesired, % desired value of a cache size of the third resource for execution of the task;

UINT32 Xeon-generational IPCmin, % desired processor characteristic (Xeon generation) and minimum value of instructions per cycle (IPC) of a fourth resource required for execution of the task;

BOOL MigrationTolerance, % a value of migration tolerance, as described further below; UINT32 Xeon IPC requirement, % requirement of IPC of the fourth resource (e.g., Xeon processor) for execution of the task;

Struct Accelerator Config[ ], % a desired configuration of a fifth resource (e.g., an accelerator) for execution of the task;

UINT32 Power_PL1_PL2, % a desired power level (PL) of the fifth resource for execution of the task;

UINT32 ReservedFields[ ] };

Struct Accelerator Config {

UINT32 Fmin,

UINT32 Fdesired,

UINT32 MemBWmin,

UINT32 MemBWdesired,

UINT32 CacheSizemin,

UINT32 CacheSizedesired,

BOOL MigrationTolerance,

UINT32 FLOPS_Efficiency, % a desired value for floating point operations per second of the fifth resource for execution of the task;

UINT32 Power_Perf Mode, % a desired setting of a power and performance mode of the fifth resource for execution of the task;

UINT32 CLK_PWR_GATING, % a desired configuration of clock and/or power gating of the fifth resource for execution of the task;

UINT32 ReservedFields[ ] };

Code 1

Optionally, the requirement may indicate artificial intelligence (AI) training/inference by using instructions AX512_VNNI, AVX512_BF16, etc. Optionally, the requirement may indicate an accelerator configuration indicating a dependency of the accelerator, e.g., dependency on GPU, SpringHill component, etc. “Reserved fields” may be left for additional system resource parameters for future scalability.

The processing circuitry 130 is configured to schedule execution of the task by reserving at least part of the resource 150 for the execution of the task based on the requirement. For instance, the processing circuitry 130 (e.g., a scheduler) may assign the part of the resource 150 to the execution of the task. For scheduling execution of the task, the processing circuitry 130 may perform any scheduling technique, such as priority, multilevel, round-robin, preemptive and/or cooperative scheduling. The processing circuitry 130 may perform the scheduling in such a way that the requirement is considered, e.g., that with the chosen scheduling technique the requirement is met or a high quality of service (QoS) is achieved according to the requirement. In some examples, the processing circuitry 130 is configured to determine an availability of the resource and schedule execution of the task based on the determined availability. The interface circuitry 120 may then, for instance, send the resulting schedule to a control component of the computing system 110 which controls the resource 150 to execute the task as scheduled.

For example, the processing circuitry 130 or means for processing 130 may be implemented using one or more processing units, one or more processing devices, any means for processing, such as a processor, a computer or a programmable hardware component being operable with accordingly adapted software. In other words, the described function of the processing circuitry 130 or means for processing 130 may as well be implemented in software, which is then executed on one or more programmable hardware components. Such hardware components may comprise a general-purpose processor, a Digital Signal Processor (DSP), a micro-controller, etc.

Conventionally, resources of a computing system may schedule a task without considering resources defined for the execution thereof. Especially, conventional systems may be unaware of resources beyond a CPU core (shared resources) of the system and therefore may cause resource leak or contention of the resource. By contrast, the apparatus 100 may provide the capability to configure, reserve and guarantee resources such as resource 150 during sensitive and non-sensitive task execution, e.g., across one or more XPUs with the possibility of augmentation to platform RDT (resource director technology) of the computing system 110. RDT may provide a framework of several component features for cache and memory monitoring and allocation capabilities which may enable tracking and control of shared resources, such as LLC and main memory bandwidth, in use by many applications, containers or virtual machines (VMs) running on the platform concurrently. The apparatus 100 may further provide the advantage to mitigate design/manufacturing limitations via software that is scalable to Datacenter Of Future (DCoF) based XPU model.

In some examples, the requirement indicates at least one of a desired range of a value of the resource to be provided for the execution of the task and a desired time interval for completion of the task. For instance, the value range may be defined by the minimum and desired values of the resource 150 as shown in the resource profile of Code 1. The processing circuitry 130 may be further configured to dynamically reschedule execution of the task based on the at least one the desired range of the resource and the desired time interval. For instance, the processing circuitry 130 may aim at achieving a high QoS for the task or a high QoS for a plurality of tasks to be executed by the computing system 110 and may therefore exploit the tolerances provided by the desired range of the resource and the time interval.

For instance, at first time instance, the processing circuitry 110 may reserve a part of the resource 150 based on the requirement, e.g., by reserving a desired (maximum) value defined by the value range. At a second time instance, e.g., due to new task requests, change of settings of already executing tasks, resource constraints, etc., the processing circuitry 130 may reschedule the execution of the task and, e.g., reduce the reserved part to a minimum value defined by the value range. Likewise, the processing circuitry 130 may change from a minimum to a maximum value of the value range—e.g., when resources of the computing system 110 are freed in the meantime—in order to achieve a higher QoS for the task. In the same manner, the processing circuitry 130 may change dynamically from any value within the value range to a different value within the value range. Such a change may be done before or during execution and one or multiple times. In this manner, the apparatus 100 may provide additional degrees of freedom to schedule execution of the task, e.g., to optimize the scheduling in terms of QoS. This may, especially, be beneficial in a multi-resource and multitasking environment.

The tolerance for migration mentioned in Code 1 above may be another means to achieve higher flexibility in scheduling the task. For example, the interface circuitry 120 may be configured to receive the tolerance for migration of the execution of the task. For instance, the tolerance for migration may be an (activity) factor specified by an application requesting the task execution. The tolerance for migration may range, e.g., from 0 to 1. It may represent a tolerance to potential change in system resource and, optionally, to node migration. For instance, a factor=0 may indicate that the task (application) cannot tolerate any change in system resource while factor=1 may indicate that the task is flexible to any change of system resources.

In response to determining a constraint of the resource 150 (e.g., the processing circuitry 130 may be configured to determine whether the resource 150 exhibits the constraint, e.g., whether the resource 150 can comply with the requirement), the processing circuitry 130 may be configured to reschedule the execution of the task by reserving a further part of the resource 150 for the execution of the task based on the requirement and the tolerance for migration. The processing circuitry 130 may, for instance, exploit the full flexibility of the tolerance for migration and change the resource reservation whenever another (e.g., less tolerant) task requests a conflicting access to the same resource 150.

In some examples, the processing circuitry 130 is configured to schedule the execution of the task by reserving at least part of a processing core of a plurality of processing cores of the computing system 110 for the execution of the task based on the requirement. The interface circuitry 120 may be configured to receive a tolerance for migration of the task to a further one of the plurality of processing cores. For instance, the migration tolerance may indicate the application or VM tolerance to migrate to a different node in case of resource constraints. The processing circuitry 130 may be configured to, in response to determining a constraint of the processing core, reschedule the execution of the task by reserving a further processing core of the plurality of processing cores for the execution of the task based on the requirement and the tolerance for migration. This may include a halting process of the task (typically milliseconds scale) till a negotiation with a different node (the further processing core) is successful. This may enable the possibility to perform node migration of the task in order to mitigate the resource constraint.

Considering the computing system 110 in a multitasking environment, the apparatus 100 may manage the resource 150 (or a plurality of resources) for a plurality of tasks. For example, the interface circuitry 120 may be configured to receive a further request to execute a further task on the computing system 110 and receive a further requirement of the further task for usage of a resource of the computing system 110. Latter resource may be a different resource or the resource 150. The processing circuitry 130 may be configured to schedule execution of the further task by reserving at least part of the resource 150 for the execution of the further task based on the further requirement of the further task and the requirement of the task. For example, the processing circuitry 130 may weigh different scheduling options for the task and the further task and determine one option which is, e.g., most promising in terms of achievable QoS based on the requirements (e.g., SLAs).

In the latter multitasking environment, the resource 150 may, in some examples, be a resource shared by a plurality of processing cores of the computing system 110. The further requirement may further indicate an at least temporary exclusive usage of a processing core of the plurality of processing cores. Such an temporary exclusive usage may, for instance, be due to sensitive data of the task to be processed on the processing core. A temporary exclusive usage may enable a mitigation of microarchitectural data sampling (MDS) attacks which aim at accessing the sensitive data without permission by executing a task on the same physical core.

The processing circuitry 130 may be configured to schedule execution of the task and the further task by allocating at least one respective thread to the task and the further task on a same processing core of the plurality of processing cores and reserving a respective part of the shared resource for the execution of the task and the further task based on the temporary exclusive usage of the processing core. That means, the processing circuitry 130 may consider the exclusive usage in the scheduling process. For instance, the processing circuitry 130 may require the task to free at least partly the shared resources before the exclusive usage by the further task begins. The processing circuitry 130 may therefore define a suitable time instance for a halting process of the task to begin the exclusive usage, e.g., a time instance where the task will naturally free a sufficient share of the shared resource. The processing circuitry 130 may further check whether the task may be degraded within its value range, time interval, and/or migration tolerance indicated by the requirement to avoid conflicts with the exclusive usage by the further task.

Alternatively, the further requirement may further indicate an at least temporary exclusive usage of the resource 150. In the latter case, the processing circuitry 130 may be configured to schedule execution of the task and the further task based on the temporary exclusive usage of the resource.

By the latter, the apparatus 100 may further enable a “Balanced Performance and Power on selective hyper-threading (HT) on homogenous and heterogenous cores for MDS mitigation”. For example, companies may prefer to disable (e.g., x86) HT mechanism to mitigate against threats such as MDS. A possible work around may be exclusive usage, e.g., disabling HT on sibling logical thread (of the task) when a sensitive workload (of the further task) runs on primary logical thread (e.g., a trusted execution environment; TEE) on the same physical core.

This work around may, conventionally, come at the cost of significant performance penalty and starvation since non-sensitive (e.g., non TEE) sibling threads (of the task) may starve if sensitive threads (of the further task) don't relinquish resources or vice-versa. Further, core level thread control may conventionally be incapable to help out as shared resources may be the cause of starvation, such as shared resources beyond the CPU cores, e.g., shared LLC, memory bandwidth, UPI, PCIe, CXL lanes, especially in a XPU centric forward-looking architecture. The apparatus 100 may therefore provide a mechanism to specify specific QoS/SLA constraints (the requirement) for enabling a scheduling to make appropriate resource reservation with time bound and data-throughput bound limitations to avoid performance and power penalties. With hetero-core capabilities, the apparatus 100 may provide for a fine-granular cost function-based thread mapping between the hetero-cores and XPUs for platform efficiency. By contrast, the conventional disablement of HT in public cloud scenarios may cause losing 50% TCO (total cost of ownership) as all vCPUs may be in halted state which is not favorable for CSPs (cloud solution providers) as well as end tenants.

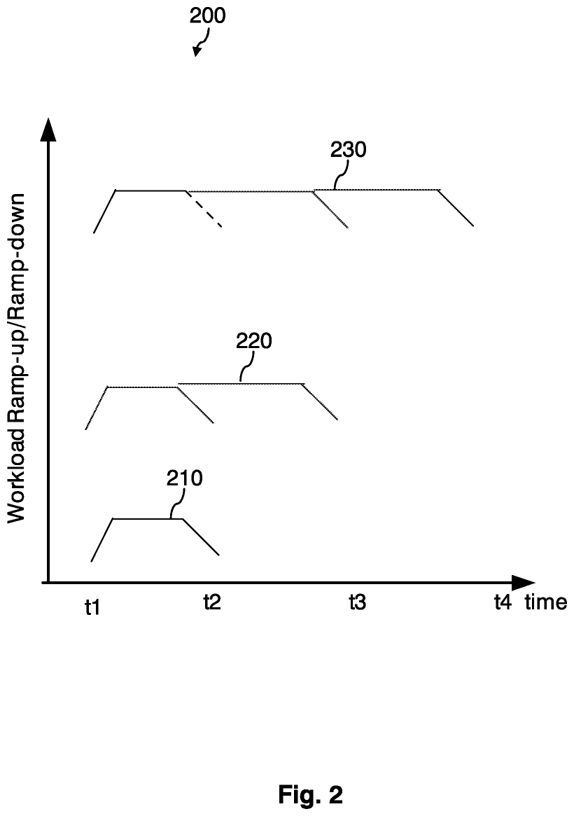

A concrete example of how the apparatus 100 may improve the HT disablement is described in the following with respect to FIG. 2. FIG. 2 illustrates an example of a schedule diagram 200 of an execution of a (first) task. The schedule diagram 200 shows scheduled ramp-ups and ramp-downs of a resource over time for the execution of the first task. The schedule diagram 200 may be determined by a conventional scheduler. Assuming, two users named Alice and Bob try to run two virtual machines (VMs) on a public cloud offering (e.g., AWS). Alice's workload (second/further task) may have a requirement to reserve one single logical core but dedicated full physical core to avoid any MDS attack scenarios. The second task is expected to start at time t1 and end by time t2. Bob's workload (first task) may have a requirement to have three dedicated logical cores and is expected to start at time t1 and complete by time t2. In an isolated private configuration, both the first and the second task would complete as per expectation at time t2, but in a shared configuration this may not happen, as explained in the following:

In a first time instance, a first schedule 210 is provided where the first task (Bob's workload) is assigned to three logical cores (Core0: HT1, Corel: HT0 & 1) on a first and a second (physical) processing core. The first schedule 210 expects the first task to start at time t1 and complete by time t2.

In a second time instance, the conventional scheduler may reschedule the execution of the first task, yielding a second schedule 220. For instance, the second task (Alice's workload) may be assigned to one logical core (Core0: HT0) of the first processing core. Since the second task is sensitive for MDS attack, hyperthreading is disabled for Core0. This leads to the logical core of the first task Core0: HT1 being disabled. In the second schedule 220 (first scenario), the first task may be starved since the execution is partly pushed from t1 to t2 due to the exclusive usage (access) of the first processing core by the second task. The scheduler expects the second task to start at time t1 and complete by time t2, and the first task to start at time t1 (on the second processing core) and complete by time t3 (assuming the second task ends by t2 as planned).

In a second scenario, the first task executed on the second processing core may consume shared resources (LLC, memory bandwidth/latency, uncore, mesh, UPI, I/O interconnect etc.) to a high (e.g., maximum) extent. The second task may have no opportunity to access these shared resources. As a result, the second task may not complete at the expected time frame of t2, mostly waiting on shared resource to be relinquished by the first task. This may lead to a deadlock type scenario where—on the one hand—the first task cannot finish in anticipated time frame of t2 due to one of the processing cores Core® being held (used exclusively) by the second task. On the other hand, the second task has not sufficient shared resources to complete as expected at t2, instead the second task will last until t3. As shown in a third schedule 230, the completion of the first task may therefore be postponed until t4.

By contrast, the proposed apparatus, such as apparatus 100, may use the (application) requirement/SLA to appropriately reserve a resource dynamically: For instance, the requirement of the second task may indicate a desired value (amount) of LLC, uncore, PCI, UPI, interconnect, memory bandwidth etc. for the execution of the second task. The apparatus 100 may reserve this desired part of the resource, thereby avoiding that it is eaten up by the first task. So, the second task may complete on schedule at time t2 and let the first task take back the core. The first task would then end as per new plan of the second schedule 220 at time t2 instead of t1. The apparatus 100 may therefore increase the dynamic flexibility and scalability of task scheduling by using appropriate resource guarantees.

In another scenario, a third user Charlie requests a third task to time share all four logical cores of the first and second processing core (Core 0: HT0 & HT1, Corel: HT0 & HT1). In this case, the apparatus 100 may check for tolerances of the first task and the second task. For instance, the requirement of the first and second task may indicate a desired value range of the resource to be provided for the execution of the task or a desired time for completion of the task. The requirement may indicate that a thread of the task may be temporarily interrupted and that the thread may sleep for a certain time duration. The apparatus 100 may, then, let the third task steal the requested resources quickly and relinquish them back to the first and the second task. The apparatus 100 may enable rescheduling based on a value range (application tolerance) indicated by the requirement. For instance, if newly scheduled resources are still falling within the value range, the proposed apparatus (orchestrator) may perform decision making (rescheduling within the value range) without bothering the application (the task), e.g., for negotiation. Alternatively, the application may indicate that a change is to be notified dynamically via provisioned policies in the requirement.

In some examples, the processing circuitry 130 is configured to, in response to determining a constraint of the resource, negotiate, with at least one of the task and the further task, a modification of at least one of the requirement and the further requirement for mitigating the constraint and reschedule the execution of at least one of the task and the further task based on the negotiated modification. The apparatus 100 may, for instance, invoke applications for negotiation only where a resource constraint is detected, e.g., when the indicated resource value range in the requirement is violated (e.g., a threshold range is exceeded).

The resource negotiation provided by the apparatus 100 may enable a tunable QoS based performance and power management scaling beyond CPU socket to platform XPUs, e.g., by specifying QoS in terms of platform power, wireless performance metrics/tolerance, etc., which is scalable across XPUs (and is not focused on top bin only). A dynamic negotiation capability as provided by the apparatus 100 may enable bidding of resource among contending applications for cloud service providers. This may combine the above-mentioned dynamic resource sharing and node migration capability with a bidding mechanism.

The apparatus 100 may also take over the control of the resources of the computing system 110, e.g., via an interface to the hardware providing the resources. In some examples, the processing circuitry 130 may therefore be configured to enforce the scheduled execution of the task based on the reserved part of the resource 150. For instance, the processing circuitry 130 may enforce the scheduled execution of the task by configuring the resource based on the requirement, e.g., by reserving the part of the resource and/or setting a configuration of the resource.

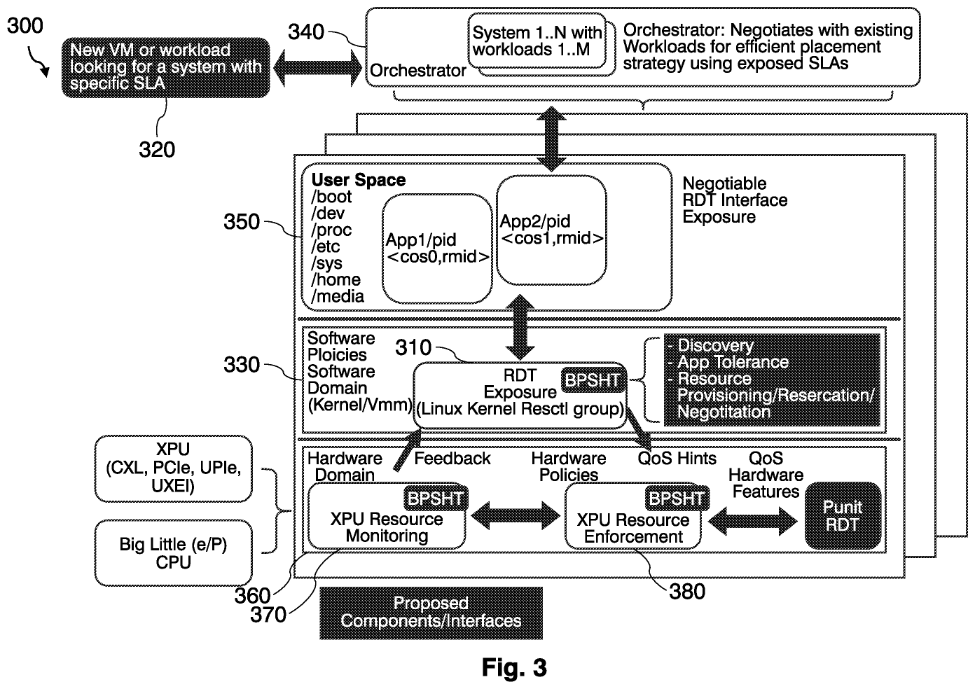

FIG. 3 illustrates an example of an architecture 300 of a computing system supporting techniques as described herein. The computing system comprises or is coupled to an apparatus 310 as proposed herein, such as apparatus 100. The apparatus 310 may be embedded into a software domain 330 (kernel/virtual machine manager VMM) of the computing system managing software policies. The apparatus 310 comprises interface circuitry configured to receive a request to execute a task 320 on the computing system and receive a requirement of the task 320 for usage of a resource of the computing system. The task may be a virtual machine or workload. The requirement may indicate an SLA.

The apparatus 310 comprises processing circuitry configured to schedule execution of the task 320 by reserving at least part of the resource for the execution of the task 320 based on the requirement. The apparatus 310 may, e.g., be coupled to an orchestrator 340 handling a plurality of tasks. The orchestrator 340 may negotiate with already accepted (existing) tasks for an efficient placement of resources, e.g., by using exposed SLAs.

The apparatus 310 may, for instance, be coupled to the orchestrator 340 via an RDT interface to a user space 350 running, e.g., two applications (tasks) App1 and App2. The apparatus 310 may comprise an RDT exposure component which is configured to enable a balancing of power and performance with selective HT, involving the following 4 stages: In the first stage (discovery of XPU resource reservation capabilities), the processing circuitry may determine availability of the resource, e.g., a resource beyond CPU cores, e.g., scaling to LLC, UPI, PCIe, CXL attach points (I/O, memory, cache) and XPUs. For determining availability of the resource, the apparatus 310 may have an interface to a hardware domain 360 of the computing system. The hardware domain 360 may comprise XPU, CXL, PCIe, UPI, UXEI, and CPU resources. The hardware domain 360 may implement an XPU resource monitoring 370 which reports monitored resources back to the apparatus 310.

In the second stage (application tolerance/activity factor), the processing circuitry may check on a tolerance for migration indicated by the requirement. This may be a factor specified by the application which ranges from 0 to 1. The factor may represent an application tolerance to potential change in system resource and consequent node migration. In the third stage (resource provisioning), the processing circuitry may check on the static or dynamic resource constraints provided by the requirement (desired value of the resource), e.g., a frequency range, memory bandwidth range, cache size range, TDP (thermal design power) range, migration tolerance, Xeon IPC range, accelerator/XPU configuration, reserved fields. In the fourth stage (resource reservation), the processing circuitry may reserve at least part of the resource for the execution of the task 320 based on the requirement, e.g., based on the determined availability, the desired value and the migration tolerance. Further, the hardware domain 360 may implement an XPU resource enforcement 380 which receives the scheduled execution from the apparatus 310 for enforcing it on the hardware.

The apparatus 310 may support the specification of an application tolerance (migration tolerance and value range) and enable a hierarchical RDT from cluster to node level with homogenous or heterogenous XPUs. The apparatus 310 may enable a resource reservation scale beyond a single logical thread of a CPU to a system/rack level by augmentation to RDT.

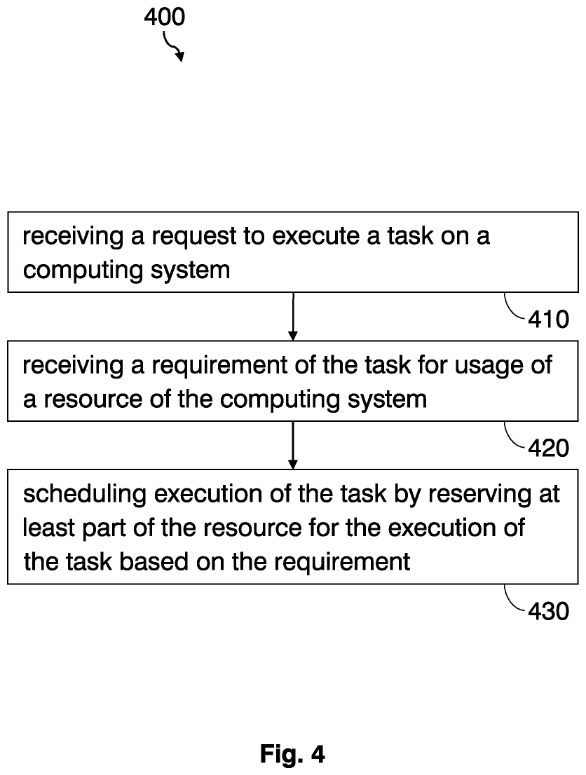

FIG. 4 illustrates an example of a (e.g., computer-implemented) method 400. An apparatus, such as apparatus 100 or 310, may be configured to execute the method 400. The method 400 comprises receiving 410 a request to execute a task on a computing system, receiving 420 a requirement of the task for usage of a resource of the computing system and scheduling 430 execution of the task by reserving at least part of the resource for the execution of the task based on the requirement.

More details and aspects of the method 400 are explained in connection with the proposed technique or one or more examples described above (e.g., FIGS. 1 to 3). The method 400 may comprise one or more additional optional features corresponding to one or more aspects of the proposed technique, or one or more examples described above.

The method 400 may provide the capability to configure, reserve and guarantee resources during sensitive and non-sensitive task execution, e.g., across one or more XPUs with the possibility of augmentation to platform RDT of the computing system.

In some examples, the resource is a resource shared by a plurality of processing cores of the computing system. In some examples, the resource is at least one of a processing resource, a storing resource and a communication resource. In some examples, the requirement indicates at least one of a desired value of the resource to be provided for the execution of the task and a desired time for completion of the task. In some examples, the requirement indicates at least one of a processing frequency, a memory bandwidth, a cache size, a processor characteristic, an interconnect latency and an accelerator configuration. In some examples, the method further comprises determining an availability of the resource and scheduling execution of the task based on the determined availability.

In some examples, the requirement indicates at least one of a desired range of a value of the resource to be provided for the execution of the task and a desired time interval for completion of the task. The method 400 further comprises dynamically rescheduling execution of the task based on the at least one the desired range of the resource and the desired time interval.

In some examples, the method 400 further comprises receiving a tolerance for migration of the execution of the task and, in response to determining a constraint of the resource, rescheduling the execution of the task by reserving a further part of the resource for the execution of the task based on the requirement and the tolerance for migration.

In some examples, the method 400 further comprises scheduling the execution of the task by reserving at least part of a processing core of a plurality of processing cores of the computing system for the execution of the task based on the requirement, receiving a tolerance for migration of the task to a further one of the plurality of processing cores and, in response to determining a constraint of the processing core, rescheduling the execution of the task by reserving a further processing core of the plurality of processing cores for the execution of the task based on the requirement and the tolerance for migration.

In some examples, the method 400 further comprises receiving a further request to execute a further task on the computing system, receiving a further requirement of the further task for usage of a resource of the computing system and scheduling execution of the further task by reserving at least part of the resource for the execution of the further task based on the further requirement of the further task and the requirement of the task.

In some examples, the further requirement further indicates an at least temporary exclusive usage of the resource. The method 400 may further comprise scheduling execution of the task and the further task based on the temporary exclusive usage of the resource. In some examples, the resource is a resource shared by a plurality of processing cores of the computing system and the further requirement further indicates an at least temporary exclusive usage of a processing core of the plurality of processing cores. The method 400 may further comprise scheduling execution of the task and the further task by allocating at least one respective thread to the task and the further task on a same processing core of the plurality of processing cores and reserving a respective part of the shared resource for the execution of the task and the further task based on the temporary exclusive usage of the processing core.

In some examples, the method 400 further comprises, in response to determining a constraint of the resource, negotiating, with at least one of the task and the further task, a modification of at least one of the requirement and the further requirement for mitigating the constraint and rescheduling the execution of at least one of the task and the further task based on the negotiated modification.

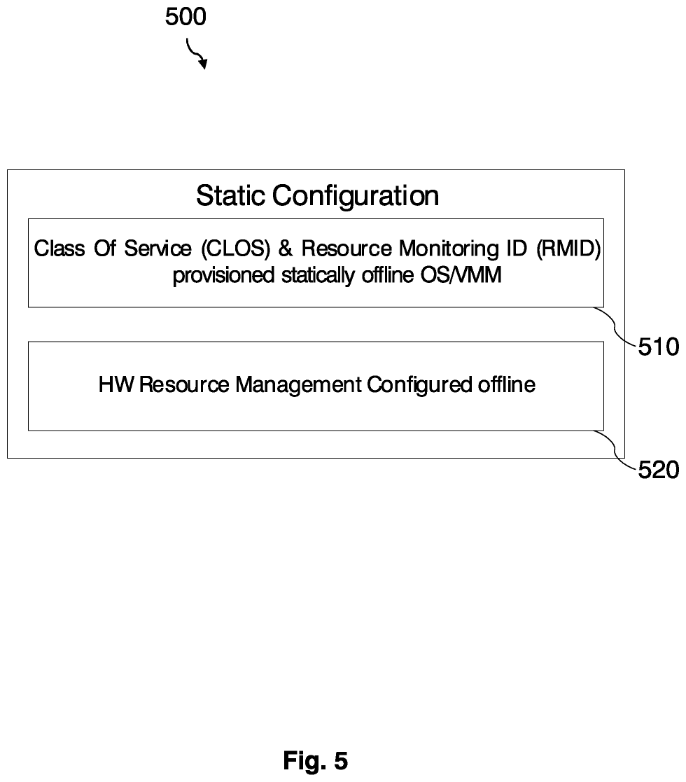

In some examples, the method 400 further comprises enforcing the scheduled execution of the task based on the reserved part of the resource. For example, the method 400 may comprise enforcing the scheduled execution of the task by (statically or dynamically) configuring the resource based on the requirement. An example of a static configuration of the resource is illustrated by FIG. 5. FIG. 5 shows a flowchart of a method 500 for static configuration of a resource. For example, the method 400 may include one or more steps of the method 500. The method 500 comprises receiving 510, in an offline state, a class of service (CLOS) and a resource monitoring ID (RMID) of the resource from the operation system (OS) or the VMM. The method 500 further comprises configuring 520, in the offline state, the resource by controlling a hardware (HW) resource management.

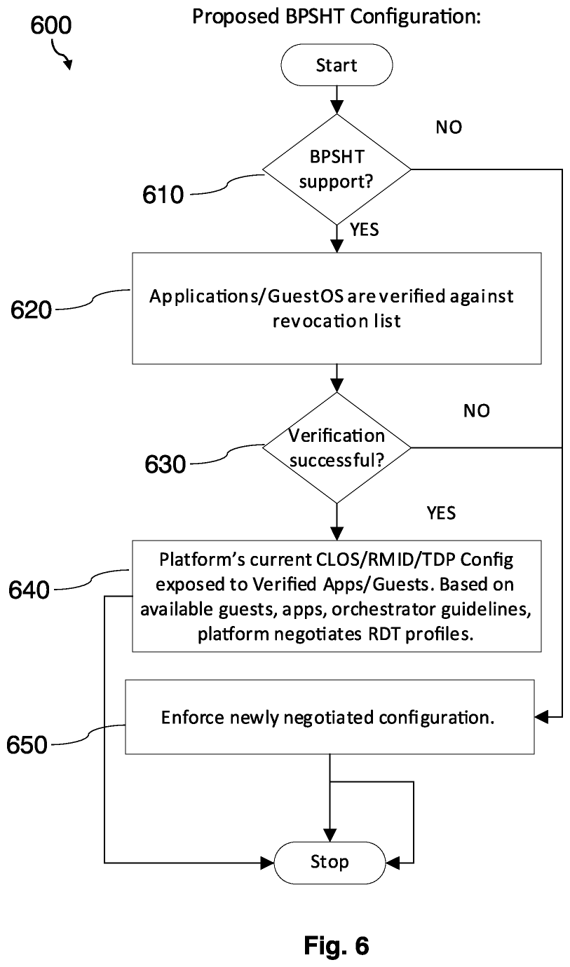

FIG. 6 illustrates an example of a method 600 for dynamic resource configuration. For example, the method 400 may include one or more steps of the method 600. The method 600 comprises verifying, in block 610, whether balanced performance and power on selective HT (BPSHT) is supported. If so, in block 620, the method 600 comprises verifying a task (application/guestOS) against a verification list. If the verification is successful in block 630, the method 600 resumes with block 640. In block 640, the method 600 comprises determining an availability of resources of the computing system requested by the task (platform's current CLOS, RMID, TDP configuration exposed to verified tasks and scheduling execution of the task based on a requirement of the task and the determined availability. The requirement (e.g., a resource or RDT profile) of the task may be negotiated with the task based on further tasks (available guests or applications) and orchestrator guidelines. In block 650, the method 600 comprises enforcing the scheduled execution of the task (newly negotiated configuration).

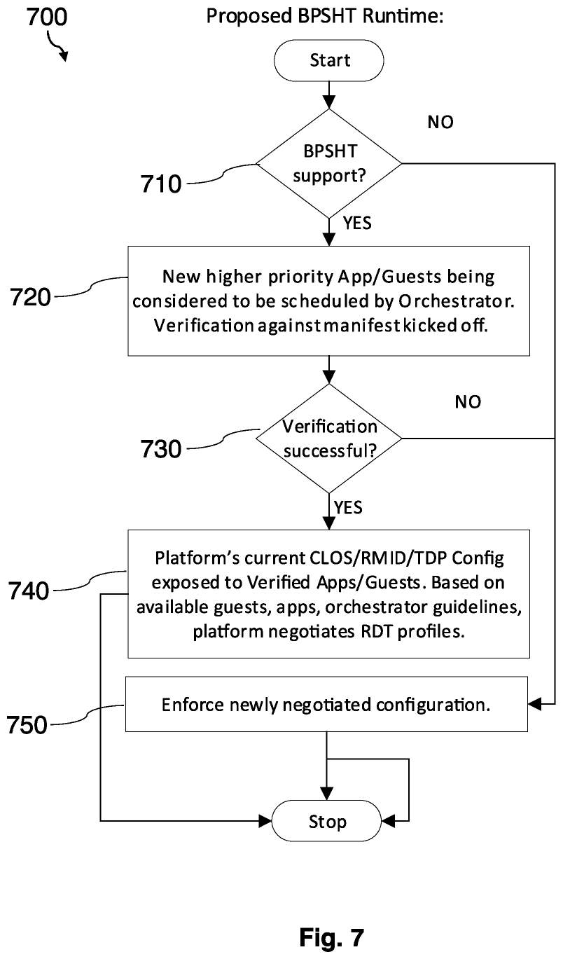

FIG. 7 illustrates an example of a method 700 for dynamic resource configuration. For example, the method 400 may include one or more steps of the method 700. The method 700 comprises verifying, in block 710, whether BPSHT is supported. If so, in block 720, the method 600 comprises verifying a high-priority task (application/guest) against a verification list (manifest). If the verification is successful in block 730, the method 700 resumes with block 740. In block 740, the method 700 comprises determining an availability of resources of the computing system requested by the task (platform's current CLOS, RMID, TDP configuration exposed to verified tasks and scheduling execution of the task based on a requirement of the task and the determined availability. The requirement (e.g., a resource or RDT profile) of the task may be negotiated (e.g., based on a bidding mechanism) with the task based on further tasks (available guests or applications) and orchestrator guidelines. In block 750, the method 700 comprises enforcing the scheduled execution of the task (newly negotiated configuration).

Apparatuses and methods described herein may provide the capability to configure, reserve and guarantee resources during sensitive and non-sensitive task execution across one or more XPUs with augmentation to platform RDT.

In the following, some examples of the proposed technique are presented:

An example (e.g., example 1) relates to an apparatus, the apparatus comprising interface circuitry, machine-readable instructions, and processing circuitry to execute the machine-readable instructions to receive a request to execute a task on a computing system, receive a requirement of the task for usage of a resource of the computing system, and schedule execution of the task by reserving at least part of the resource for the execution of the task based on the requirement.

Another example (e.g., example 2) relates to a previous example (e.g., example 1) or to any other example, further comprising that the resource is a resource shared by a plurality of processing cores of the computing system.

Another example (e.g., example 3) relates to a previous example (e.g., one of the examples 1 or 2) or to any other example, further comprising that the resource is at least one of a processing resource, a storing resource and a communication resource.

Another example (e.g., example 4) relates to a previous example (e.g., one of the examples 1 to 3) or to any other example, further comprising that the instructions comprise instructions to determine an availability of the resource and schedule execution of the task based on the determined availability.

Another example (e.g., example 5) relates to a previous example (e.g., one of the examples 1 to 4) or to any other example, further comprising that the requirement indicates at least one of a desired value of the resource to be provided for the execution of the task and a desired time for completion of the task.

Another example (e.g., example 6) relates to a previous example (e.g., one of the examples 1 to 5) or to any other example, further comprising that the requirement indicates at least one of a desired range of a value of the resource to be provided for the execution of the task and a desired time interval for completion of the task, wherein the instructions comprise instructions to dynamically reschedule execution of the task based on the at least one the desired range of the resource and the desired time interval.

Another example (e.g., example 7) relates to a previous example (e.g., one of the examples 1 to 6) or to any other example, further comprising that the requirement indicates at least one of a processing frequency, a memory bandwidth, a cache size, a processor characteristic, an interconnect latency and an accelerator configuration.

Another example (e.g., example 8) relates to a previous example (e.g., one of the examples 1 to 7) or to any other example, further comprising that the instructions comprise instructions to receive a tolerance for migration of the execution of the task, and in response to determining a constraint of the resource, reschedule the execution of the task by reserving a further part of the resource for the execution of the task based on the requirement and the tolerance for migration.

Another example (e.g., example 9) relates to a previous example (e.g., one of the examples 1 to 8) or to any other example, further comprising that the instructions comprise instructions to schedule the execution of the task by reserving at least part of a processing core of a plurality of processing cores of the computing system for the execution of the task based on the requirement, receive a tolerance for migration of the task to a further one of the plurality of processing cores, and in response to determining a constraint of the processing core, reschedule the execution of the task by reserving a further processing core of the plurality of processing cores for the execution of the task based on the requirement and the tolerance for migration.

Another example (e.g., example 10) relates to a previous example (e.g., one of the examples 1 to 9) or to any other example, further comprising that the instructions comprise instructions to receive a further request to execute a further task on the computing system, receive a further requirement of the further task for usage of a resource of the computing system, and schedule execution of the further task by reserving at least part of the resource for the execution of the further task based on the further requirement of the further task and the requirement of the task.

Another example (e.g., example 11) relates to a previous example (e.g., example 10) or to any other example, further comprising that the further requirement further indicates an at least temporary exclusive usage of the resource, and wherein the instructions comprise instructions to schedule execution of the task and the further task based on the temporary exclusive usage of the resource.

Another example (e.g., example 12) relates to a previous example (e.g., example 10) or to any other example, further comprising that the resource is a resource shared by a plurality of processing cores of the computing system, wherein the further requirement further indicates an at least temporary exclusive usage of a processing core of the plurality of processing cores, and wherein the instructions comprise instructions to schedule execution of the task and the further task by allocating at least one respective thread to the task and the further task on a same processing core of the plurality of processing cores, and reserving a respective part of the shared resource for the execution of the task and the further task based on the temporary exclusive usage of the processing core.

Another example (e.g., example 13) relates to a previous example (e.g., one of the examples 10 to 12) or to any other example, further comprising that the instructions comprise instructions to in response to determining a constraint of the resource, negotiate, with at least one of the task and the further task, a modification of at least one of the requirement and the further requirement for mitigating the constraint, and reschedule the execution of at least one of the task and the further task based on the negotiated modification.

Another example (e.g., example 14) relates to a previous example (e.g., one of the examples 1 to 13) or to any other example, further comprising that the instructions comprise instructions to enforce the scheduled execution of the task based on the reserved part of the resource.

Another example (e.g., example 15) relates to a previous example (e.g., example 14) or to any other example, further comprising that the instructions comprise instructions to enforce the scheduled execution of the task by configuring the resource based on the requirement.

An example (e.g., example 16) relates to a method, comprising receiving a request to execute a task on a computing system, receiving a requirement of the task for usage of a resource of the computing system, and scheduling execution of the task by reserving at least part of the resource for the execution of the task based on the requirement.

Another example (e.g., example 17) relates to a previous example (e.g., example 16) or to any other example, further comprising that the resource is a resource shared by a plurality of processing cores of the computing system.

Another example (e.g., example 18) relates to a previous example (e.g., one of the examples 16 or 17) or to any other example, further comprising that the requirement indicates at least one of a desired value of the resource to be provided for the execution of the task and a desired time for completion of the task.

Another example (e.g., example 19) relates to a previous example (e.g., one of the examples 16 to 18) or to any other example, further comprising that the resource is at least one of a processing resource, a storing resource and a communication resource.

Another example (e.g., example 20) relates to a previous example (e.g., one of the examples 16 to 19) or to any other example, further comprising determining an availability of the resource and scheduling execution of the task based on the determined availability.

Another example (e.g., example 21) relates to a previous example (e.g., one of the examples 16 to 20) or to any other example, further comprising that the requirement indicates at least one of a desired range of a value of the resource to be provided for the execution of the task and a desired time interval for completion of the task, and wherein the method further comprises dynamically rescheduling execution of the task based on the at least one the desired range of the resource and the desired time interval.

Another example (e.g., example 22) relates to a previous example (e.g., one of the examples 16 to 21) or to any other example, further comprising that the requirement indicates at least one of a processing frequency, a memory bandwidth, a cache size, a processor characteristic, an interconnect latency and an accelerator configuration.

Another example (e.g., example 23) relates to a previous example (e.g., one of the examples 16 to 22) or to any other example, further comprising receiving a tolerance for migration of the execution of the task, and in response to determining a constraint of the resource, rescheduling the execution of the task by reserving a further part of the resource for the execution of the task based on the requirement and the tolerance for migration.

Another example (e.g., example 24) relates to a previous example (e.g., one of the examples 16 to 23) or to any other example, further comprising scheduling the execution of the task by reserving at least part of a processing core of a plurality of processing cores of the computing system for the execution of the task based on the requirement, receiving a tolerance for migration of the task to a further one of the plurality of processing cores, and in response to determining a constraint of the processing core, rescheduling the execution of the task by reserving a further processing core of the plurality of processing cores for the execution of the task based on the requirement and the tolerance for migration.

Another example (e.g., example 25) relates to a previous example (e.g., one of the examples 16 to 24) or to any other example, further comprising receiving a further request to execute a further task on the computing system, receiving a further requirement of the further task for usage of a resource of the computing system, and scheduling execution of the further task by reserving at least part of the resource for the execution of the further task based on the further requirement of the further task and the requirement of the task.

Another example (e.g., example 26) relates to a previous example (e.g., example 25) or to any other example, further comprising that the further requirement further indicates an at least temporary exclusive usage of the resource, and wherein the method comprises scheduling execution of the task and the further task based on the temporary exclusive usage of the resource.

Another example (e.g., example 27) relates to a previous example (e.g., example 25) or to any other example, further comprising that the resource is a resource shared by a plurality of processing cores of the computing system, wherein the further requirement further indicates an at least temporary exclusive usage of a processing core of the plurality of processing cores, wherein the method further comprises scheduling execution of the task and the further task by allocating at least one respective thread to the task and the further task on a same processing core of the plurality of processing cores, and reserving a respective part of the shared resource for the execution of the task and the further task based on the temporary exclusive usage of the processing core.

Another example (e.g., example 28) relates to a previous example (e.g., one of the examples 25 to 27) or to any other example, further comprising in response to determining a constraint of the resource, negotiating, with at least one of the task and the further task, a modification of at least one of the requirement and the further requirement for mitigating the constraint, and rescheduling the execution of at least one of the task and the further task based on the negotiated modification.

Another example (e.g., example 28) relates to a previous example (e.g., one of the examples 16 to 27) or to any other example, further comprising enforcing the scheduled execution of the task based on the reserved part of the resource.

Another example (e.g., example 29) relates to a previous example (e.g., example 28) or to any other example, further comprising enforcing the scheduled execution of the task by configuring the resource based on the requirement.

Another example (e.g., example 30) relates to a non-transitory machine-readable storage medium including program code, when executed, to cause a machine to perform the method of a previous example (e.g., one of examples 16 to 29).

An example (e.g., example 31) relates to an apparatus, the apparatus comprising interface circuitry and processing circuitry, the interface circuitry being configured to receive a request to execute a task on a computing system and receive a requirement of the task for usage of a resource of the computing system, the processing circuitry being configured to schedule execution of the task by reserving at least part of the resource for the execution of the task based on the requirement.

Another example (e.g., example 32) relates to a previous example (e.g., example 31) or to any other example, further comprising that the resource is a resource shared by a plurality of processing cores of the computing system.

Another example (e.g., example 33) relates to a previous example (e.g., one of the examples 31 or 32) or to any other example, further comprising that the resource is at least one of a processing resource, a storing resource and a communication resource.

Another example (e.g., example 34) relates to a previous example (e.g., one of the examples 31 to 33) or to any other example, further comprising that the processing circuitry is configured to determine an availability of the resource and schedule execution of the task based on the determined availability.

Another example (e.g., example 35) relates to a previous example (e.g., one of the examples 31 to 34) or to any other example, further comprising that the requirement indicates at least one of a desired value of the resource to be provided for the execution of the task and a desired time for completion of the task.

Another example (e.g., example 36) relates to a previous example (e.g., one of the examples 31 to 35) or to any other example, further comprising that the requirement indicates at least one of a desired range of a value of the resource to be provided for the execution of the task and a desired time interval for completion of the task, the processing circuitry being configured to dynamically reschedule execution of the task based on the at least one the desired range of the resource and the desired time interval.

Another example (e.g., example 37) relates to a previous example (e.g., one of the examples 31 to 36) or to any other example, further comprising that the requirement indicates at least one of a processing frequency, a memory bandwidth, a cache size, a processor characteristic, an interconnect latency and an accelerator configuration.

Another example (e.g., example 38) relates to a previous example (e.g., one of the examples 31 to 37) or to any other example, further comprising that the interface circuitry is configured to receive a tolerance for migration of the execution of the task, and the processing circuitry being configured to, in response to determining a constraint of the resource, reschedule the execution of the task by reserving a further part of the resource for the execution of the task based on the requirement and the tolerance for migration.

Another example (e.g., example 39) relates to a previous example (e.g., one of the examples 31 to 38) or to any other example, further comprising that the processing circuitry is configured to schedule the execution of the task by reserving at least part of a processing core of a plurality of processing cores of the computing system for the execution of the task based on the requirement, the interface circuitry being configured to receive a tolerance for migration of the task to a further one of the plurality of processing cores, the processing circuitry being configured to, in response to determining a constraint of the processing core, reschedule the execution of the task by reserving a further processing core of the plurality of processing cores for the execution of the task based on the requirement and the tolerance for migration.

Another example (e.g., example 40) relates to a previous example (e.g., one of the examples 31 to 39) or to any other example, further comprising that the interface circuitry is configured to receive a further request to execute a further task on the computing system, receive a further requirement of the further task for usage of a resource of the computing system, and the processing circuitry being configured to schedule execution of the further task by reserving at least part of the resource for the execution of the further task based on the further requirement of the further task and the requirement of the task.

Another example (e.g., example 41) relates to a previous example (e.g., example 40) or to any other example, further comprising that the further requirement further indicates an at least temporary exclusive usage of the resource, and the processing circuitry being configured to schedule execution of the task and the further task based on the temporary exclusive usage of the resource.

Another example (e.g., example 42) relates to a previous example (e.g., example 40) or to any other example, further comprising that the resource is a resource shared by a plurality of processing cores of the computing system, wherein the further requirement further indicates an at least temporary exclusive usage of a processing core of the plurality of processing cores, and the processing circuitry being configured to schedule execution of the task and the further task by allocating at least one respective thread to the task and the further task on a same processing core of the plurality of processing cores, and reserving a respective part of the shared resource for the execution of the task and the further task based on the temporary exclusive usage of the processing core.

Another example (e.g., example 43) relates to a previous example (e.g., one of the examples 40 to 42) or to any other example, further comprising that the processing circuitry is configured to, in response to determining a constraint of the resource, negotiate, with at least one of the task and the further task, a modification of at least one of the requirement and the further requirement for mitigating the constraint, and reschedule the execution of at least one of the task and the further task based on the negotiated modification.

Another example (e.g., example 44) relates to a previous example (e.g., one of the examples 30 to 43) or to any other example, further comprising that the processing circuitry is configured to enforce the scheduled execution of the task based on the reserved part of the resource.

Another example (e.g., example 45) relates to a previous example (e.g., example 44) or to any other example, further comprising that the processing circuitry is configured to enforce the scheduled execution of the task by configuring the resource based on the requirement.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computerreadable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and sub combinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus, the apparatus comprising interface circuitry, machine-readable instructions, and processing circuitry to execute the machine-readable instructions to:
receive a request to execute a task on a computing system;
receive a requirement of the task for usage of a resource of the computing system; and
schedule execution of the task by reserving at least part of the resource for the execution of the task based on the requirement.

2. The apparatus of claim 1, wherein the resource is a resource shared by a plurality of processing cores of the computing system.

3. The apparatus of claim 1, wherein the resource is at least one of a processing resource, a storing resource and a communication resource.

4. The apparatus of claim 1, wherein the instructions comprise instructions to determine an availability of the resource and schedule execution of the task based on the determined availability.

5. The apparatus of claim 1, wherein the requirement indicates at least one of a desired value of the resource to be provided for the execution of the task and a desired time for completion of the task.

6. The apparatus of claim 1, wherein the requirement indicates at least one of a desired range of a value of the resource to be provided for the execution of the task and a desired time interval for completion of the task, wherein the instructions comprise instructions to dynamically reschedule execution of the task based on the at least one the desired range of the resource and the desired time interval.

7. The apparatus of claim 1, wherein the requirement indicates at least one of a processing frequency, a memory bandwidth, a cache size, a processor characteristic, an interconnect latency and an accelerator configuration.

8. The apparatus of claim 1, wherein the instructions comprise instructions to:
receive a tolerance for migration of the execution of the task; and
in response to determining a constraint of the resource, reschedule the execution of the task by reserving a further part of the resource for the execution of the task based on the requirement and the tolerance for migration.

9. The apparatus of claim 1, wherein the instructions comprise instructions to:
schedule the execution of the task by reserving at least part of a processing core of a plurality of processing cores of the computing system for the execution of the task based on the requirement;
receive a tolerance for migration of the task to a further one of the plurality of processing cores; and
in response to determining a constraint of the processing core, reschedule the execution of the task by reserving a further processing core of the plurality of processing cores for the execution of the task based on the requirement and the tolerance for migration.

10. The apparatus of claim 1, wherein the instructions comprise instructions to:
receive a further request to execute a further task on the computing system;
receive a further requirement of the further task for usage of a resource of the computing system; and
schedule execution of the further task by reserving at least part of the resource for the execution of the further task based on the further requirement of the further task and the requirement of the task.

11. The apparatus of claim 10, wherein the further requirement further indicates an at least temporary exclusive usage of the resource, and wherein the instructions comprise instructions to schedule execution of the task and the further task based on the temporary exclusive usage of the resource.

12. The apparatus of claim 10, wherein the resource is a resource shared by a plurality of processing cores of the computing system, wherein the further requirement further indicates an at least temporary exclusive usage of a processing core of the plurality of processing cores, and wherein the instructions comprise instructions to schedule execution of the task and the further task by:
allocating at least one respective thread to the task and the further task on a same processing core of the plurality of processing cores; and
reserving a respective part of the shared resource for the execution of the task and the further task based on the temporary exclusive usage of the processing core.

13. The apparatus of claim 10, wherein the instructions comprise instructions to:
in response to determining a constraint of the resource, negotiate, with at least one of the task and the further task, a modification of at least one of the requirement and the further requirement for mitigating the constraint; and
reschedule the execution of at least one of the task and the further task based on the negotiated modification.

14. The apparatus of claim 1, wherein the instructions comprise instructions to enforce the scheduled execution of the task based on the reserved part of the resource.

15. The apparatus of claim 14, wherein the instructions comprise instructions to enforce the scheduled execution of the task by configuring the resource based on the requirement.

16. A method, comprising:
receiving a request to execute a task on a computing system;
receiving a requirement of the task for usage of a resource of the computing system; and
scheduling execution of the task by reserving at least part of the resource for the execution of the task based on the requirement.

17. The method of claim 16, wherein the requirement indicates at least one of a desired range of a value of the resource to be provided for the execution of the task and a desired time interval for completion of the task, and wherein the method further comprises dynamically rescheduling execution of the task based on the at least one the desired range of the resource and the desired time interval.

18. The method of claim 16, further comprising:
receiving a tolerance for migration of the execution of the task; and
in response to determining a constraint of the resource, rescheduling the execution of the task by reserving a further part of the resource for the execution of the task based on the requirement and the tolerance for migration.

19. The method of claim 16, further comprising:
scheduling the execution of the task by reserving at least part of a processing core of a plurality of processing cores of the computing system for the execution of the task based on the requirement;
receiving a tolerance for migration of the task to a further one of the plurality of processing cores; and
in response to determining a constraint of the processing core, rescheduling the execution of the task by reserving a further processing core of the plurality of processing cores for the execution of the task based on the requirement and the tolerance for migration.

20. The method of claim 16, further comprising:
receiving a further request to execute a further task on the computing system;
receiving a further requirement of the further task for usage of a resource of the computing system; and
scheduling execution of the further task by reserving at least part of the resource for the execution of the further task based on the further requirement of the further task and the requirement of the task.

21. The method of claim 20, wherein the further requirement further indicates an at least temporary exclusive usage of the resource, and wherein the method comprises scheduling execution of the task and the further task based on the temporary exclusive usage of the resource.

22. The method of claim 20, wherein the resource is a resource shared by a plurality of processing cores of the computing system, wherein the further requirement further indicates an at least temporary exclusive usage of a processing core of the plurality of processing cores, wherein the method further comprises scheduling execution of the task and the further task by:
allocating at least one respective thread to the task and the further task on a same processing core of the plurality of processing cores; and
reserving a respective part of the shared resource for the execution of the task and the further task based on the temporary exclusive usage of the processing core.

23. The method of claim 20, further comprising:
in response to determining a constraint of the resource, negotiating, with at least one of the task and the further task, a modification of at least one of the requirement and the further requirement for mitigating the constraint; and
rescheduling the execution of at least one of the task and the further task based on the negotiated modification.

24. The method of claim 16, further comprising enforcing the scheduled execution of the task based on the reserved part of the resource.

25. A non-transitory machine-readable storage medium including program code, when executed, to cause a machine to perform the method of claim 16.
